(19) United States
(12) Patent Application Publication
(10) Pub. No.: US 2010/0024935 A1
(43) Pub. Date: Feb. 4, 2010

(54) USAGE OF MICRON OR SUBMICRON SIZE TRANSPARENT OR TRANSLUCENT BEADS TO IMPROVE REFLECTANCE

(75) Inventors: Nusrallah Jubran, St. Paul, MN (US); Jerry D. Hoyt, Hastings, MN (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/185,210

(22) Filed: Aug. 4, 2008

(51) Int. Cl. B60C 1/00; C09D 5/00; B05D 1/36

(52) U.S. Cl. 152/151; 106/31.01; 427/203; 106/31.95

(57) ABSTRACT

A reflectant coating composition includes a binding agent and a plurality of transparent or translucent beads immersed within the binding agent.

### FIELD OF THE INVENTION

The present invention relates generally to the field of reflective coatings using transparent or translucent beads. In particular, the present invention relates to compositions with transparent or translucent beads for making surfaces glossy or shiny.

### BACKGROUND OF THE INVENTION

A shiny or glossy surface is associated with a new or clean object. Gloss enhancing products may be used in various applications including cleaning and sanitation products used in customer counters and service areas, and coatings for floor finish and vehicle care. In vehicle care applications, a glossy coating or dressing may be applied onto the surface of a tire to enhance the overall appearance of the tire. For example, the coating may be applied onto the tires at a car dealership to enhance the appearance of the car in order to increase the likelihood of a sale, or the coating may be applied onto the tires after the car has been washed to give the tires a “cleaner” look.

Reflectant coatings or dressings on tires, are temporary and typically remain on the surface of the tire for between a few hours and a few days. The lifetime of the coatings depends on various factors such as the environment, the temperature, the weather, and the composition of the dressing. The shininess of the tire, as measured by luminous reflectance, may also depend on the composition of the coating. A concern with tire dressings is the presence of volatile organic compounds (VOCs), which are detrimental to the environment. In general, VOCs include C₁₃ and lower compounds which can include certain hydrocarbons. As the tire dressings are applied, the tire dressings release VOCs into the environment. Legislation may eventually ban the use of VOCs in products. It is against this background that the present invention is made.

### BRIEF SUMMARY OF THE INVENTION

Surprisingly, it has been discovered that a reflectant coating composition can be achieved using transparent beads or translucent beads. Accordingly, the invention includes a tire dressing composition with a plurality of transparent beads immersed within the tire dressing. The invention has the advantage of being environmentally friendly in that it does not need to use VOCs to make a surface shiny.

### BRIEF DESCRIPTION OF THE DRAWINGS

FIG. 1 is a cross-sectional view of a reflectant dressing on a surface of a tire.

FIG. 2 is a diagram of a method of applying a monolayer reflectant dressing onto a surface of a tire.

FIG. 3 is a diagram of a method of applying a multilayer reflectant dressing onto a surface of a tire.

### DETAILED DESCRIPTION

The present invention includes a composition with transparent or translucent beads. The composition can be used as a dressing on the surface of a tire, or in any application where a reflective surface is desired. The composition may be used in conjunction with cleaning products on small-scale surfaces such as countertops, cabinetry and appliances; for floor finish enhancement or general floor care; and for general vehicle care as vehicle dressings, polishes and waxes applied to the exterior of the vehicle.

The composition generally includes a binding agent, a plurality of transparent or translucent beads immersed within the binding agent, and additional optional ingredients to enhance the performance of the product.

### Binding Agent

The composition includes a binding agent to adhere the beads onto a surface. The binding agent can include silicone, hydrocarbons, or hydrocarbon/silicone blends. In an exemplary embodiment, the composition of the binding agent may be a commercially available tire dressing.

Some examples of silicones include silicone emulsions such as emulsions formed from methyl (dimethyl), higher alkyl and aryl silicones; functionalized silicones such as chlorosilanes; amino-, methoxy-, epoxy-, and vinyl-substituted siloxanes; and silanols. Suitable silicone emulsions include E2175 high viscosity polydimethylsiloxane (a 60% siloxane emulsion commercially available from Lambent Technologies, Inc.), E21456 FG food grade intermediate viscosity polydimethylsiloxane (a 35% siloxane emulsion commercially available from Lambent Technologies, Inc.), HV490 high molecular weight hydroxyl-terminated dimethyl silicone (an anionic 30-60% siloxane emulsion commercially available from Dow Corning Corporation), SM2135 polydimethylsiloxane (a nonionic 50% siloxane emulsion commercially available from GE Silicones) and SM2167 polydimethylsiloxane (a cationic 50% siloxane emulsion commercially available from GE Silicones). Other silicone materials include finely divided silicone powders such as the TOSPEARL™ series (commercially available from Toshiba Silicone Co. Ltd.); and silicone surfactants such as SWP30 anionic silicone surfactant, WASWS-P nonionic silicone surfactant, QUATQ-400M cationic silicone surfactant and 703 specialty silicone surfactant (all commercially available from Lambent Technologies, Inc.).

Siloxanes are conventionally represented by the formula R₃SiO(R₂SiO)ₓSiR₃ where R is a methyl group and x is an integer having a value that corresponds to the viscosity of the particular siloxane. For example, a trimethyl end-blocked dimethylsiloxane oil having a viscosity of 1000 centistokes at 25° C. can be represented as having the average formula Me₃SiO(Me₂SiO)₄₈₀SiMe₃ wherein Me is a methyl radical. It is understood that the siloxane oils used in this invention are usually mixtures of various discrete siloxane species, due at least in part, to the fact the starting materials used to produce the siloxane oils are themselves usually mixtures.

Exemplary hydrocarbons include all possible structures of C₆-C₁₈ aromatic or aliphatic hydrocarbons, which can be linear or branched or cyclic, and can be substituted. Examples include hexane, heptane, octane, nonane, decane, dodecane, cyclohexane, cycloheptane, cyclooctane, 2,2-dimethyl-butane, 2,2-dimethyl-pentane, 2,2,3,3-tetramethyl-pentane, 2,2,3,3,4,4,-hexamethyl-pentane, and the like. An example also includes triglycerides and mineral oil.

In some embodiments, the composition includes a hydrocarbon/silicone oil blend. In this embodiment, the blend may include a ratio of 80:20, 85:15, or 75:25, hydrocarbon to silicone oil.

A preferred binding agent includes a dimethyl siloxane. An exemplary dimethyl siloxane consists of siloxy units of the formula R₂SiO and end-blocking siloxy units of the formula R₃SiO wherein R is a methyl radical. As employed herein such siloxane oils are essentially linear siloxane polymers having a viscosity in the range of about 100 to about 60000 centistokes at about 25° C. preferably about 300 to about 10000 centistokes at about 25° C.

### Transparent or Translucent Beads

The composition includes transparent beads immersed in the binding agent which increase the luster of the surface, resulting in a richer and deeper shine. In an embodiment, the addition of the beads to the binding agent increases the luminous reflectance of the surface by between about 13% and about 80% when measured at a twenty degree angle and by between about 12% and about 71% when measured at a sixty degree angle by a BYK-Gardner glossmeter (Rivers Park II ((Columbia, Md.)). The beads are preferably formed of a microscopic, and reflective material that has a higher index of refraction than the indices of refraction of the surface and binding agent. Some examples of beads include glass, organic polymer particles, inorganic particles, organometallic particles, and quartz. Specific examples of organic polymer particles include polyethylene, polypropylene, polycarbonate and polyacrylamide. Glass has an index of refraction of between about 1.5 and about 1.52, polyacrylamide has an index of refraction of between about 1.49 and about 1.492, and polycarbonate has an index of refraction of between about 1.584 and about 1.586. The beads may be spherical, disc, solid, hollow, irregular, sphere-like, cylindrical, egg, or orb in shape, or may be any shape capable of providing the desired reflection properties.

The transparent beads are preferably sized to increase the reflectance of the surface while remaining substantially indistinguishable to the human eye. Generally, for a given luminous reflectance, the size or diameter of the beads and the loading of the beads are inversely related. Thus, as the size of the beads decreases, the loading of the beads must be increased to achieve the same luminous reflectance. In an exemplary embodiment, the beads are between about 0.1 micron and about 100 microns in diameter, or between about 4 microns and about 20 microns in diameter. The average diameter of the beads in the binding agent may be substantially similar to each other, or the beads may have varying diameters. The loading of the beads will depend on a variety of factors, including the average diameter of the beads and the desired luminous reflectance of surface. In an embodiment, the beads have a loading of between about 0.1% and about 60%, or between about 0.5% and about 5% weight percent.

### Additional Ingredients

In addition to the binding agent and the beads, the composition may optionally include additional ingredients to enhance the performance of the product. Some examples of additional ingredients include a diluent, gloss enhancing agent, emulsifying agent, viscosity modifier, thickener, surfactant, preservative, light stabilizer, leveling aid, color, fragrance and mixtures of these ingredients.

Some examples of diluents include water and organic solvents. Examples of organic solvents include aliphatic hydrocarbons, aromatic hydrocarbons, mineral seal oil, and chlorinated organic solvents. Specific names and trade names include mineral spirits/stoddard solvent (saturated C₈-C₁₂ hydrocarbons), solvent 140, and Isopar (C, E, G, H, K, L, M, V) (commercially available from Exxon Corp.). In an embodiment, the composition is free of any solvents. In an embodiment, the composition is free of hydrocarbons with chain lengths of C₁₃ and lower.

The composition may include a gloss enhancing agent to increase the luminous reflectance of the composition. Examples of commercially available gloss enhancers include Dow Corning®IE 349 Emulsion, an intermediate viscosity polydimethylsiloxane (a nonionic 60% polysiloxane emulsion available from Dow Corning Corporation), Dow Corning 531 and 536 amino-functional polysiloxane polymers (available from Dow Corning Corporation), GE 2163NPF Emulsion, an intermediate viscosity polydimethylsiloxane (a nonionic, 60% polysiloxane emulsion available from GE Silicone, General Electric Corporation), GE 1706 fluid, a amino-functional polysiloxane fluid (available from GE Silicones, General Electric Corporation), Lambent 2145HG Emulsion, an intermediate viscosity polydimethylsiloxane (a nonionic 60% polysiloxane emulsion available from Lambent Technology) and Carnuaba Wax Emulsion, a 50% cationic/carnuaba wax emulsion available from Tomah Products, Milton, Wis.

Exemplary viscosity modifiers and thickeners include natural polymers or gums derived from plant or animal sources such as large polysaccharide molecules having substantial thickening capacity, soluble organic thickeners such as carboxylated vinyl polymers such as polyacrylic acids and sodium salts thereof, boric acid, diethanolamide, coco-diethanolamide, coco-monoethanolamide, stearic-diethanolamide, ethoxylated cellulose, hydroxyethyl styrylamide, oleic-diethanolamide, stearic-monoethanolamide, cetyl alcohol, steroyl alcohol, polyacrylamide thickeners, ethanol glycol disterate, xanthan compositions, sodium alginate and algin products, hydroxypropyl cellulose, and hydroxyethyl cellulose. Additional thickeners are xanthan thickeners sold by the Kelco Division of Merck under the tradenames KELTROL, KELZAN AR, KELZAN D35, KELZAN S, KELZAN XZ, and others.

Examples of commercially available thickening agents include Acusol (15-50% water emulsion polyacrylate polymers) available from Rohm & Haas Co., Philadelphia, Pa.; Pemulan (high molecular weight co-polymers of acrylic acid and C10-C30 alkyl acrylate) and Carbopol Polymers (crosslinked acrylic acid/polyalkenyl polyether polymers) available from Noveon, Cleveland, Ohio.

The composition may include a surfactant or surface active agent to help produce a homogeneous, stable product. Surface active agents are any compound that reduces interfacial tension between two liquids, or between a liquid and a solid, or that reduces surface tension when dissolved in water or water solutions. Examples of surface active agents, or surfactants, include wetting agents, emulsifiers, detergents, and the like, and specifically nonionic, cationic, anionic, amphoteric and zwitterionic surfactants.

The composition optionally include a preservative to maintain or preserve the formulation. Examples of some preservatives include antioxidants and biocides. Suitable antioxidants include butylated hydroxyanisole (BHA), butylated hydroxytoluene (BHT), propyl gattate, and others generally known. Suitable biocides agents include any substance that inhibits the growth of microorganisms such as bacteria, molds, slimes, fungi, viruses, and the like. Examples of suitable biocides include methyl and proply parabens, sodium o-phenylphenol, aldehydes (formaldehyde, glutaraldehyde), amines (quaternary compounds, amine and diamine), sulfur compounds (isothiazolone, carbamates, metronidazole), quaternary phosphonium salts, thiazolinones, zinc pyrithione, and gluconate.

The composition may include a light stabilizer. Examples of light stabilizers include hindered amines such as Chimassorb 119F, Chimassorb 994, Chimassorb 2020, Flamestab NOR 116, Tinuvin 123, Tinuvin 144, Tinuvin 622, Tinuvin 765, Tinuvin 770, Tinuvin XT 850 commercially available from Ciba, Inc. (Basel, Switzerland), and UV absorbers such as Chimassorb 81, Tinuvin 213, Tinuvin 234, Tinuvin 326, Tinuvin P, Tinuvin 571 commercially available from Ciba, Inc. (Basel, Switzerland).

The composition may include a leveling aid to help spread the composition on a surface. Some examples of leveling aids include fatty acids such as capric acid, lauric acid, myristic acid, palmitic acid, stearic acid, uraclidic acid, behenic acid, cerotic acid, carboceric acid, montanic acid, melissic acid, lacceroic acid, geddic acid, ceroplastic acid and all their possible esters; fatty amines such as aliphatic amines whose alkyl group contain 8-22 carbon atoms where the aliphatic group can be linear, branched or cyclic, castrol oil or its sulfonated derivative, and all possible structures of linear alcohols with 2-5 ethylene oxide (EO) units.

The composition may include ingredients to enhance the color or fragrance of the composition. Dyes may be included to alter the appearance of the composition.

Fragrances or perfumes that may be included in the compositions include, for example, terpenoids such as citronellol, aldehydes such as amyl cinnamaldehyde, a jasmine such as CIS-jasmine or jasmal, vanillin, banana, and the like.

The materials of the composition may be present in various weight percents. Exemplary weight percent ranges are provided in the following table.

| | |
|---|---|
| Raw Material | Weight Percent Ranges |

| | | | |
|---|---|---|---|
| Binding Agent | 20-80 | 30-60 | 40-50 |
| Beads | 0.1-60 | 0.1-30 | 0.1-15 |
| Diluent | 1.0-99.0 | 5.0-90.0 | 10.0-75.0 |
| Gloss Enhancer | 0.1-75 | 0.1-50 | 0.1-25 |
| Emulsifier | 0.5-20 | 0.1-15 | 0.2-10 |
| Viscosity Modifier | 0.01-10.0 | 0.05-5.0 | 0.1-3.0 |
| Thickener | 0.05-10 | 0.1-5 | 0.15-2.5 |
| Surfactant | 0.1-10.0 | 0.15-6.0 | 0.2-5.0 |
| Preservatives | 0.001-10 | 0.01-5 | 0.15-2.5 |
| Light Stabilizer | 0.001-10 | 0.01-5 | 0.15-2.5 |
| Leveling Aid | 0.01-10 | 0.5-5.0 | 0.1-2.5 |
| Color | 0.001-10 | 0.01-5 | 0.15-2.5 |
| Fragrance | 0.001-10 | 0.01-5 | 0.15-2.5 |

### Application

The coating may be applied onto a surface as a monolayer system or as a multilayer system. In a monolayer system, the beads are mixed with the binding agent to form a homogeneous coating prior to applying the coating onto a surface. In a multilayer system, the beads are applied onto a surface, with a binding agent being applied over the beads to adhere the beads to a surface. For both a monolayer and multilayer system, the binding agent is applied onto a surface to a thickness of at least the diameter of the beads to prevent the beads from protruding from the binding agent. In an embodiment, the binding agent is applied onto a surface to a thickness of between about 0.1 microns and about 1000 microns, or between about 10 microns and about 60 microns. The coating may be applied onto a surface using any method known in the art, including manual application, spray application, or by a dressing applicator. The composition may be a liquid, emulsion, gel, paste, foam, cream, lotion, wax, or solid. The coating may be used as a car wax composition, with the surface including the vehicle body as well as the vehicle tires.

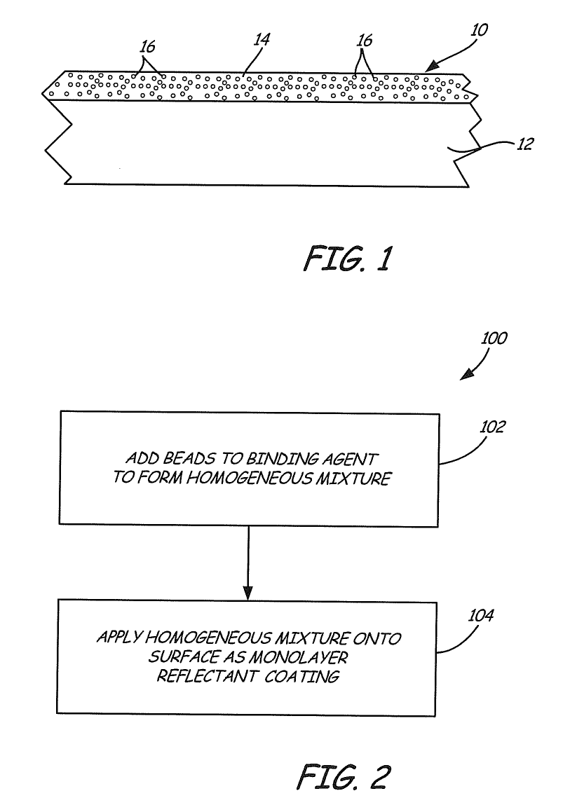

FIG. 1 shows a cross-sectional view of reflectant coating 10 on surface 12.

FIG. 2 shows a diagram of a method 100 of applying a monolayer reflectant coating 10 onto surface 12. As shown in Box 102, beads 16 are first added to and mixed with binding agent 14 to form a homogeneous mixture. In an embodiment, beads 16 are between about 0.1 microns and about 100 microns in diameter and are loaded at between about 0.1% and about 60%. After beads 16 and binding agent 14 are mixed together to form a homogeneous mixture, the homogeneous mixture is applied onto surface 12 as a monolayer reflectant coating 10, Box 104. Monolayer reflectant coating 10 is applied onto surface 12 to a thickness of at least the average diameter of beads 16. In an embodiment, monolayer reflectant coating 10 is applied onto surface 12 to a thickness of between about 0.1 microns and about 1000 microns.

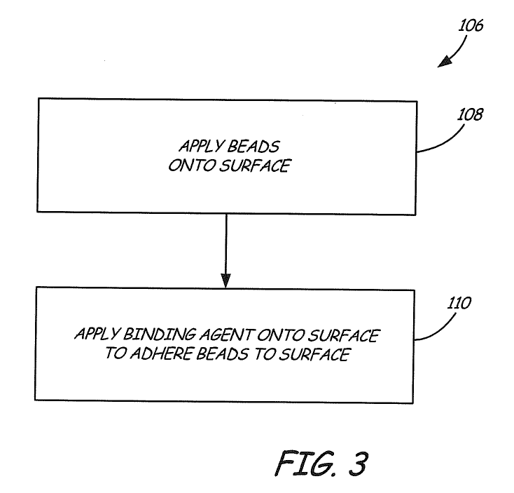

FIG. 3 shows a diagram of a method 106 of applying a multilayer reflectant coating 10 onto surface 12. To form multilayer reflectant coating 10, beads 16 are first applied onto surface 12, Box 108. In an exemplary embodiment, beads 16 are between about 0.1 microns and about 100 microns in diameter. After beads 16 have been applied onto surface 12, binding agent 14 is applied over beads 16 to adhere beads 16 to surface 12, Box 110. Multilayer reflectant coating 10 is applied to a thickness of at least the average diameter of beads 16. In an exemplary embodiment, multilayer reflectant coating 10 is applied onto surface 12 to a thickness of between about 0.1 microns and about 1000 microns.

### EXAMPLES

The present invention is described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The following test method was used to characterize the compositions produced in the examples:

### Luminous Reflectance

A rubber coupon was first cut into a first sample, a second sample, and a third sample. Each of the samples was about 4 inches by 2 inches in size. The first rubber sample was treated as a control sample and was not altered. A single layer of a tire dressing (no glass beads) was applied onto the second rubber sample. The third rubber sample was coated with a layer of the tire dressing applied onto the second rubber sample. However, the tire dressing was also mixed with about 3% loading of about 30 micron diameter glass beads. The samples were then allowed to dry prior to measuring the luminous reflectance factor of each of the samples with a 20 degree glossmeter and a 60 degree glossmeter (BYK-Gardner glossmeter, Rivers Park II (Columbia, Md.)). The luminous reflectance factor, or gloss, was measured relative to highly polished glass (assigned a value of 100 based on ASTM D523). The glossmeters were also calibrated with the control rubber sample. To determine the luminous reflectance factors, or net gloss, of the second and third samples, the luminous reflectance factor of the control rubber sample was subtracted from the luminous reflectance factor measured for the second and third samples. This process was repeated four times and the results were averaged. The higher the luminous reflectance factor of the sample, the glossier the sample appeared to be.

### Tire Dressing Used

| | |
|---|---|
| Example 1 | Ecolab Cream Protectant (a commercially available water |
| | based silicone emulsion, interior surface dressing). |
| Example 2 | Ecolab Super Express Wax (a commercially available |
| | water based silicone/hydrocarbon fluid emulsion, |
| | exterior vehicle polish). |
| Example 3 | Ecolab Black Magic (a commercially available water based |
| | silicone emulsion tire dressing). |
| Example 4 | Ecolab All Purpose (a commercially available water based |
| | silicone emulsion, tire and interior surface dressing). |
| Example 5 | Ecolab Tirewet (a commercially available water based |
| | polyacrylate/polypropylene dispersion tire dressing). |
| Example 6 | Ecolab On-line Tire Dressing (a commercially available |
| | water based polyacrylate/silicone dispersion tire dressing). |

Examples 1, 2, 3, 4, 5, and 6 were tested using six different tire dressings. Table 1 provides the luminous reflectance factors of the control samples, the luminous reflectance factors of the samples having a layer of a tire dressing applied onto the surface of the samples, and the luminous reflectance of the samples having a layer of a tire dressing and including approximately 3% loading of approximately 30 micron diameter glass beads applied onto the surface of the samples. The samples were measured at a 20 degree angle and a 60 degree angle with the method discussed above.

TABLE 1

| | | | Tire Dressing + 3% 30 |
|---|---|---|---|
| | Control - No Tire | Tire Dressing | micron glass beads |
| | Dressing (20°/60°) | (20°/60°) | (20°/60°) |
| Example 1 | 0.2/2.0 | 0.3/3.8 | 0.9/8.6 |
| Example 2 | 0.2/2.1 | 0.1/0.6 | 0.5/2.1 |
| Example 3 | 0.2/2.1 | 0.6/7.0 | 1.0/9.0 |
| Example 4 | 0.2/2.2 | 0.2/2.5 | 0.9/5.5 |
| Example 5 | 0.23/2.4 | 2.0/14.6 | 2.3/16.5 |
| Example 6 | 0.23/2.3 | 0.8/3.5 | 1.2/6.7 |

As can be seen in Table 1, all of Examples 1-6 exhibited increased glossiness, or luminous reflectance, upon application of the base tire dressing. The luminous reflectance factors of the samples of Examples 1-6 further increased when the 30 micron diameter glass beads were added to the base tire dressing at a loading of approximately 3%. In particular, when the samples were observed at a 20 degree angle, the luminous reflectance factor of Example 1 increased by approximately 67%; the luminous reflectance factor of Example 2 increased by approximately 80%; the luminous reflectance factor of Example 3 increased by approximately 40%; the luminous reflectance factor of Example 4 increased by approximately 78%; the luminous reflectance factor of Example 5 increased by approximately 13%; and the luminous reflectance factor of Example 6 increased by approximately 33%.

The luminous reflectance factors of Examples 1-6 also increased when measured at a 60 degree angle. In particular, when the samples were observed at 60 degrees, the luminous reflectance factor of Example 1 increased by approximately 56%; the luminous reflectance factor of Example 2 increased by approximately 71%; the luminous reflectance factor of Example 3 increased by approximately 22%; the luminous reflectance factor of Example 4 increased by approximately 55%; the luminous reflectance factor of Example 5 increased by approximately 12%; and the luminous reflectance factor of Example 6 increased by approximately 48%.

After it was observed that the luminous reflectance factors of Examples 1-6 increased with the application of the base tire dressing mixed with approximately 3% loading of approximately 30 micron diameter glass beads, a second layer of the base tire dressing having approximately 3% loading of approximately 30 micron diameter glass beads was applied onto the sample of Example 1. Table 2 shows the result of applying the second layer of the base tire dressing having approximately 3% loading of approximately 30 micron diameter glass beads onto the sample.

TABLE 2

| | Base Tire Dressing + | Base Tire Dressing + two layers |
|---|---|---|
| | one layer of 3% 30 | of 3% 30 micron glass beads |
| | micron beads (20°/60°) | (20°/60°) |
| Example 1 | 0.9/8.6 | 1.5/10.2 |

As can be seen in Table 2, the luminous reflectance factor of the sample of Example 1 further increased with the application of a second layer of the base tire dressing having of the base tire dressing having approximately 3% loading of approximately 30 micron diameter glass beads 3% loading of the base tire dressing having approximately 3% loading of approximately 30 micron diameter glass beads 30 micron diameter glass beads. In particular, the luminous reflectance factor increased from 0.9 to 1.5 when observed at a 20 degree angle and increased from 8.6 to 10.2 when observed at a 60 degree angle. The luminous reflectance factor of the sample of Example 1 thus increased by approximately 40% when measured at 20 degrees and by approximately 16% when measured at 60 degrees.

Although the present invention has been described with reference to preferred embodiments, workers skilled in the art will recognize that changes may be made in form and detail without departing from the spirit and scope of the invention.

What is claimed is:

1. A reflectant coating composition comprising:
(a) a tire dressing; and
(b) a plurality of transparent or translucent beads immersed within the tire dressing.

2. The reflectant coating composition of claim 1, wherein the beads are formed of a material selected from the group consisting of glass, organic polymer particles, inorganic particles, organometallic particles, quartz, and mixtures thereof.

3. The reflectant coating composition of claim 2, wherein the organic polymer particles are selected from the group consisting of polyethylene, polypropylene, polyacrylamide and mixtures thereof.

4. The reflectant coating composition of claim 1, wherein the beads are between about 0.1 microns and about 100 microns in diameter.

5. The reflectant coating composition of claim 4, wherein the beads are between about 4 microns and about 20 microns in diameter.

6. The reflectant coating composition of claim 1, wherein the reflectant coating composition has a loading of beads of between about 0.1% and about 60%.

7. The reflectant coating composition of claim 6, wherein the reflectant coating composition has a loading of beads of between about 0.5% and about 5%.

8. A reflectant tire comprising:
(a) a tire having an outer surface;
(b) a dressing applied onto the outer surface of the tire, wherein the dressing is formed of a binding agent and a plurality of transparent or translucent beads immersed in the binding agent.

9. The reflectant tire of claim 9, wherein the beads are formed of a material selected from the group consisting of glass, organic polymer particles, inorganic particles, organometallic particles, quartz and mixtures thereof.

10. The reflectant tire of claim 9, wherein the organic polymer particles are selected from the group consisting of polyethylene, polypropylene, polyacrylamide and mixtures thereof.

11. The reflectant tire of claim 8, wherein the beads are between about 0.1 microns and about 100 microns in diameter.

13. The reflectant tire of claim 11, wherein the beads are between about 4 microns and about 20 microns in diameter.

14. The reflectant tire of claim 8, wherein the dressing has a loading of beads of between about 0.1% and about 60%.

15. The reflectant tire of claim 8, wherein the dressing has a thickness of between about 0.1 microns and about 1000 microns.

16. A method of applying a reflectant dressing onto a surface of a tire, the method comprising:
(a) applying a plurality of transparent or translucent beads onto the surface of the tire; and
(b) applying a binding agent onto the surface of the tire.

17. The method of claim 15, wherein applying the binding agent onto the surface of the tire comprises applying the binding agent to a thickness of between about 0.1 microns and about 1000 microns.

18. The method of claim 16, wherein applying the binding agent onto the surface of the tire comprises applying the binding agent to a thickness of between about 10 microns and about 3 millimeters.

19. The method of claim 15, wherein applying the plurality of beads onto the surface of the tire comprises applying a plurality of beads between about 0.1 microns and about 100 microns in diameter.

20. The method of claim 15, wherein applying the plurality of beads onto the surface of the tire and applying the binding agent onto the surface of the tire occur simultaneously.

21. The method of claim 19, wherein applying the plurality of beads and binding onto the surface of the tire simultaneously comprises mixing the plurality of beads and binding agent to form a coating having a bead loading of between about 0.1% and about 60%.
